(19) United States
(12) Patent Application Publication
(10) Pub. No.: US 2014/0315096 A1
(43) Pub. Date: Oct. 23, 2014

(54) CLAY- BASED ENERGY STORAGE COMPOSITIONS FOR HIGH TEMPERATURE APPLICATIONS

(71) Applicants: Raquel Silveira Borges, Belo Horizonte (BR); Kaushik Kalaga, Houston, TX (US); Marco Tulio Fonseca Rodrigues, Houston, TX (US); Hemtej Gullapalli, Missouri City, TX (US); Leela Mohana Reddy Arava, Houston, TX (US); Kaushik Balakrishnan, Tucson, AZ (US); Glaura Goulart Silva, Belo Horizonte (BR); Pulickel M. Ajayan, Houston, TX (US)

(72) Inventors: Raquel Silveira Borges, Belo Horizonte (BR); Kaushik Kalaga, Houston, TX (US); Marco Tulio Fonseca Rodrigues, Houston, TX (US); Hemtej Gullapalli, Missouri City, TX (US); Leela Mohana Reddy Arava, Houston, TX (US); Kaushik Balakrishnan, Tucson, AZ (US); Glaura Goulart Silva, Belo Horizonte (BR); Pulickel M. Ajayan, Houston, TX (US)

(73) Assignees: Universidade Federal de Minas Gerais, Belo Horizonte (BR); William Marsh Rice University, Houston, TX (US)

(21) Appl. No.: 14/191,089

(22) Filed: Feb. 26, 2014

Related U.S. Application Data
(60) Provisional application No. 61/769,358, filed on Feb. 26, 2013.

(51) Int. Cl. H01G 11/54; H01M 10/0565

(52) U.S. Cl. CPC H01G 11/54; H01M 10/0565
USPC 429/300; 429/188; 429/340; 429/339; 429/336; 429/341; 429/328; 429/326; 429/199; 429/304; 252/62.2; 361/502

(57) ABSTRACT

In some embodiments, the present disclosure pertains to energy storage compositions that comprise a clay and an ionic liquid. In some embodiments, the clay is a bentonite clay and the ionic liquid is a room temperature ionic liquid (RTIL). In some embodiments, the clay and the ionic liquid are present in the energy storage compositions of the present disclosure in a weight ratio of 1:1. In some embodiments, the ionic liquid further comprises a lithium-containing salt that is dissolved in the ionic liquid. In some embodiments, the energy storage compositions of the present disclosure further comprise a thermoplastic polymer, such as polyurethane. In some embodiments, the thermoplastic polymer constitutes about 10% by weight of the energy storage composition. In some embodiments, the energy storage compositions of the present disclosure are associated with components of energy storage devices, such as electrodes and separators. In some embodiments, the energy storage compositions of the present disclosure are associated with an energy storage device, such as a battery or a capacitor.

### CROSS-REFERENCE TO RELATED APPLICATIONS

This application claims priority to U.S. Provisional Patent Application No. 61/769,358, filed on Feb. 26, 2013. The entirety of the aforementioned application is incorporated herein by reference.

### STATEMENT REGARDING FEDERALLY SPONSORED RESEARCH

Not applicable.

### BACKGROUND

The demand for high temperature rechargeable energy storage devices is prominent in numerous industries, including the drilling industry and the military. However, many of the current systems operate well below 100° C. A significant limitation in attaining high temperature operation of energy storage devices (e.g., rechargeable lithium ion batteries and supercapacitors) is the electrolyte. Therefore, a need exists for the development of a new family of electrolytes that are designed to operate at high temperatures.

### SUMMARY

In some embodiments, the present disclosure pertains to energy storage compositions that comprise a clay and an ionic liquid (also referred to as clay-based energy storage compositions). In some embodiments, the clay is selected from the group consisting of bentonite clay, montmorillonite clay, kaolinite clay, tonstein clay, laponite clay and combinations thereof. In some embodiments, the clay comprises a bentonite clay.

In some embodiments, the ionic liquids in the energy storage compositions of the present disclosure include a cationic component and an anionic component. In some embodiments, the cationic components of the ionic liquids include, without limitation, sulfonium-based structures, imidazolium-based structures, pyridinium-based structures, piperidinium-based structures, pyrrolidinium-based structures, pyrazolium-based structures, ammonium-based structures, phosphonium-based structures, and combinations thereof. In some embodiments, the anionic components of the ionic liquids in the energy storage compositions of the present disclosure include, without limitation, bis(trifluoromethylsulfonyl)imide, hexafluorophosphate, methanesulfanate, triflate, tetrafluoroborate, and combinations thereof.

In some embodiments, the ionic liquids in the energy storage compositions of the present disclosure comprise a room temperature ionic liquid (RTIL). In some embodiments, the ionic liquids in the energy storage compositions of the present disclosure include, without limitation, 1-Butyl-2,3-dimethylimidazolium bis(trifluoromethylsulfonyl)imide (BMMI-TFSI), 1-Butyl-1-methylpiperidinium bis(trifluoromethylsulfonyl)imide, 1-Butyl-3-methylimidazolium hexafluorophosphate, 1-Butyl-3-methylimidazolium tetrafluoroborate, 1-Methyl-1-propylpiperidinium bis(trifluoromethylsulfonyl)imide, 1-Butyl-1-methylpiperidinium bis(trifluoromethylsulfonyl)imide (PP-TFSI), Diethylmethylsulfonium bis(trifluoromethylsulfonyl)imide, N,N-diethyl-N-methyl-N-(2-methoxyethyl)ammonium bis(trifluoromethylsulfonyl)imide, and combinations thereof.

In some embodiments, the ionic liquids in the energy storage compositions of the present disclosure further comprise a salt or a combination of salts dissolved in the ionic liquid. In some embodiments, the total concentration of one or more salts dissolved in an ionic liquid includes, without limitation, 0.2 mol L⁻¹, 0.5 mol L⁻¹, 0.8 mol L⁻¹ and 1 mol L⁻¹. In some embodiments, the one or more salts includes a lithium-containing salt (e.g., where lithium is the cation of at least one of the salts dissolved in the ionic liquid). In some embodiments, the lithium-containing salts include, without limitation, Lithium bis(trifluoromethylsulfonyl)imide (LiTFSI), Lithium Hexafluorophosphate, Lithium Tetrafluoroborate, Lithium bis(oxalate)borate (LiBOB) and combinations thereof.

In some embodiments, the clay and the ionic liquid are present in the energy storage compositions of the present disclosure in various weight ratios. In some embodiments, the clay to ionic liquid weight ratios include, without limitation, 1:1, 1:2, 1:5, 1:10, 2:1, 5:1, or 10:1.

In some embodiments, the energy storage compositions of the present disclosure further comprise a thermoplastic polymer. In some embodiments, the thermoplastic polymer includes, without limitation, polyurethanes, polyacrylates, polyamides, polyimides, polyimidazoles, polystyrene, poly(vinyl chloride), poly (vinylidene difluoride), and combinations thereof. In some embodiments, the thermoplastic polymer is a poly(urethane). In some embodiments, the thermoplastic polymer constitutes about 10% by weight of the energy storage composition.

In some embodiments, the energy storage compositions of the present disclosure are in solid form. In some embodiments, the energy storage compositions of the present disclosure are in a paste form. In some embodiments, the energy storage compositions of the present disclosure are in the form of a film. In some embodiments, the energy storage compositions of the present disclosure are freestanding.

In some embodiments, the energy storage compositions of the present disclosure are associated with components of energy storage devices, such as electrodes and separators. In some embodiments, the energy storage compositions of the present disclosure are associated with an energy storage device, such as a battery or a supercapacitor. In some embodiments, the energy storage compositions of the present disclosure serve as electrolytes or electrolyte and separator in energy storage devices.

### DESCRIPTION OF THE FIGURES

FIG. 1 provides a schematic of the individual components of a supercapacitor device that contains a clay-based energy storage composition as the electrolyte. As illustrated in FIG. 1A, the electrolyte includes clay and a room temperature ionic liquid (clay:RTIL). The clay:RTIL is between two reduced graphene oxide (RGO) layers that serve as electrodes. As illustrated in the scanning electron microscopy (SEM) images in FIG. 1B, the RGO/clay:RTIL half capacitor configuration shows a good interfacial adhesion between electrode and electrolyte.

FIG. 2 provides images of various clay-based energy storage compositions, including: optical pictures of the compositions after treatment at different temperatures (FIG. 2A); and SEM images of half capacitor configurations (FIGS. 2B-C) that contain the compositions within the context of current collectors and reduced graphene oxide (RGO) electrodes. The SEM images show transversal cell images at different magnitudes.

FIG. 3 shows various data relating to the electrical properties of the RTIL, 1-Butyl-2,3-dimethylimidazolium bis(trifluoromethylsulfonyl)imide (BMMI-TFSI). FIG. 3A shows cyclic voltammograms for the RTIL using different voltage windows at 50 mV·s⁻¹ and stainless steel current collectors. The RTIL shows stable behavior without any significant reaction between −3V and +3V. FIG. 3B shows cyclic voltammograms for supercapacitors based on RGO electrodes and the RTIL as electrolytes (with celgard separators). The measurements were conducted at room temperature and 100° C. using a 60 mV·s⁻¹ scan rate. FIG. 3C shows a specific capacitance vs voltage window for capacitors that are based on RGO electrodes and the RTIL as electrolytes for cells tested at room temperature and at 100° C. FIG. 3D shows Galvanostatic charge-discharge measurements at 100° C. for capacitors that are based on RGO electrodes and the RTIL as electrolytes. A current rate of 4 A/g and a voltage of 2V were used.

FIG. 4 shows various data relating to the thermal and electrochemical properties of the RTIL, BMMI-TFSI, and when mixed with clay. FIG. 4A shows Thermogravimetric curves for the RTIL (black), clay (red) and clay:RTIL (blue) using a 10° C./min heating rate. FIG. 4B shows an Arrhenius plot for the ionic conductivities of the RTIL and for a 1:1 mixture of clay:RTIL. FIG. 4C shows Galvanostatic charge-discharge measurements at 200° C. for supercapacitors based on RGO electrodes and clay:RTIL as electrolytes. A voltage of 2V was used. FIG. 4D shows cycling stability of the supercapacitor RGO|clay:RTIL|RGO at 200° C. and 180° C. tested with different voltage windows (1.5V, 2V and 2.5V).

FIG. 5 shows various data relating to the electrical properties of energy storage compositions containing clay, BMMI-TSFI as RTIL, and a thermoplastic polyurethane (TPU). FIG. 5A shows an image of a freestanding membrane fabricated out of TPU, clay and RTIL. The membrane works as an electrolyte/separator for supercapacitors until 200° C. FIG. 5B shows Arrhenius plots for the ionic conductivities of a mixture containing clay and RTIL, and a free standing membrane containing TPU, clay and RTIL. FIG. 5C shows cyclic voltammograms for supercapacitors based on RGO electrodes and free standing membranes (containing TPU, clay and RTIL) as electrolytes. The measurements were conducted at room temperature, 120° C., and 200° C. by using a 60 mV·s⁻¹ scan rate. FIG. 5D shows specific capacitance as a function of temperature and current density for the supercapacitors utilizing a free standing membrane (containing TPU, clay and RTIL) as electrolytes. A broad range of current density was applied without loss in capacitor behavior.

FIG. 6 shows a thermogravimetric (TG) curve (FIG. 6A) and a derivate of TG (DTG) curve (FIG. 6B) for the graphene oxide (GO, black) and reduced graphene oxide (RGO, red). The tests were carried out using 5° C./min heating rate in air. The results show a high reduction degree of RGO.

FIG. 7 shows SEM images of RGO electrodes at different magnifications.

FIG. 8 shows the infrared absorption spectra of bentonite clay (black), the RTIL, BMMI-TFSI (red) and a clay-based energy storage composition containing the clay and the RTIL after exhaustive wash (blue). The arrows indicate BMMI-TFSI characteristic peaks that can be observed on clay-based energy storage compositions, even after the washing away of the excess adsorbed RTIL, indicating a great compatibility between the clay and the RTIL.

FIG. 9 shows the Raman spectrum of bentonite clay compared with the spectrum of montmorillonite obtained from a database. The peaks show consistency. This measurement supports the supplier information about the composition and purity level of the bentonite clay.

FIG. 10 shows secondary electrons SEM images for bentonite clay (FIG. 10A) and clay-based energy storage compositions that include bentonite clay and the RTIL BMMI-TFSI (FIG. 10B). The SEM images indicate no significant changes in clay morphology, even after the addition of the RTIL. However, a certain degree of swelling of the clay platelets is observed.

FIG. 11 shows cyclic voltammograms at 60 mV·s⁻¹ for supercapacitors with RGO electrodes and clay-based energy storage compositions that include bentonite clay and the RTIL BMMI-TFSI (RGO/clay:RTIL/RGO). The capacitor exhibits a box-like shape using a potential window of 5V at different temperatures including room temperature (RT), 120° C. and 200° C. No significant oxidation or reduction is observed.

FIG. 12 shows Galvanostatic charge-discharge measurements at 200° C. for capacitors with clay-based energy storage compositions that include bentonite clay, TPU, and the RTIL BMMI-TFSI (TPU:clay:RTIL). The capacitive behavior can still be observed at high temperatures, demonstrating that the clay-based energy storage composition works at high temperatures and large voltage windows.

FIG. 13 shows the specific capacitance at different temperatures of supercapacitor devices containing activated carbon (AC) and single-wall carbon nanotube (SWNT) electrodes with clay-based energy storage compositions that include bentonite clay and the RTIL BMMI-TFSI.

FIG. 14 summarizes the high temperature performance of supercapacitor devices fabricated from RGO electrodes and clay-based energy storage compositions that include bentonite clay and the RTIL BMMI-TFSI. This combination allows for reaching capacities as high as 80 F/g at 200° C.

FIG. 15 provides a schematic of a process for the fabrication of clay-based energy storage compositions and their use as electrolytes in energy storage devices.

FIG. 16 provides Arrhenius plots for the ionic conductivities of various electrolyte systems, including mixtures of BMMI-TFSI and lithium bis(trifluoromethylsulfonyl)imide (LiTFSI) with different salt concentrations (IM-LTFSI) (FIG. 16A), a 1 mol L⁻¹ solution LiTFSI in the RTIL 1-Butyl-1-methylpiperidinium bis(trifluoromethylsulfonyl)imide (PP-LTFSI) (FIG. 16B), mixtures of bentonite clay and IM-LTFSI (CIM-LTFSI) with different concentrations of LiTFSI (FIG. 16C), and mixtures of clay and PP-LTFSI (CPP-LTFSI) (FIG. 16D).

FIG. 17 provides cyclic voltammograms of LTO half cells containing CPP-LTFSI tested at both room temperature and 120° C. (FIGS. 17A-B) and containing CIM-LTFSI (FIG. 17C), tested with a scan rate of 0.01 mV s⁻¹.

FIG. 18 provides charge discharge profile (FIG. 18A) and cyclic stability plots (FIG. 18B) of LTO half cells containing CPP-LTFSI. The half cells were operated at a temperature of 120° C. and a current density of 20 mA/g. The plot depicts a stable capacity retention by the battery, even at high temperatures.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

There have been several innovations in electrochemical energy storage during the last decade to address the critical demands of power delivery. For instance, following the discovery and mass production of carbon nanomaterials, graphene and their derivatives have been used as electrode components in energy storage devices (e.g., supercapacitors and batteries) due to their optimal electrochemical properties.

However, the use of energy storage devices at high temperatures has been a challenge. In many examples, the limiting component in using energy storage devices at high temperatures is the stability of the electrolyte. For instance, though aqueous electrolytes are easy to handle, they cannot sustain higher temperatures. Likewise, organic electrolytes (e.g., salts dissolved in organic solvents, such as acetonitrile) have low boiling points (e.g., around 80° C.), which leads to an increase in the vapor pressure upon heating, thus raising safety concerns for operations at high temperatures.

Room-temperature ionic liquids (RTILs) have been considered as alternative electrolytes to address some of the aforementioned issues. RTILs have several advantages, such as negligible vapor pressure within the temperatures of its thermal stability range, non-flammability, thermal stability, low toxicity and electrochemical stability upon broad potential range. The drawback of using RTILs in energy storage devices is their lower ionic conductivity (as compared to aqueous electrolytes), especially at lower temperatures, due to their high viscosity. However, they become less viscous at elevated temperatures and hence they will present properties that are more suitable for energy storage applications (e.g., increased ionic conductivity and improved ionic accessibility to the porous structure of electrodes due to the lower viscosity) without undergoing thermal degradation or leading to a pressure build up within the cell. As such, RTILs have been used in energy storage devices at temperatures up to 100° C.

Though RTILs can withstand much higher temperatures, the separator (i.e., an electronic insulator component of energy storage devices that encapsulates the electrolyte and is an ion-permeable membrane separating the electrodes) limits its temperature stability. Several separators (e.g., cellulose papers, cellophane fabrics, polymers, asbestos, and glass wool) have been used for ambient temperature operations. However, such separators are not very reliable at higher temperatures (e.g., temperatures greater than 100° C.).

Various methods have combined the electrolyte and the separator into a single component by developing a family of solid and gelled electrolytes. However, energy storage devices containing such components have not displayed optimal performance at temperatures above 100° C.

Therefore, a need exists for more thermally stable energy storage compositions that are operable in energy storage devices at temperatures above 100° C. The energy storage compositions of the present disclosure address this need.

In some embodiments, the present disclosure pertains to energy storage compositions. In some embodiments, the energy storage compositions of the present disclosure include a clay and an ionic liquid. In some embodiments the ionic liquids of the present disclosure also include a salt or a combination of salts dissolved in the ionic liquids. In further embodiments, the energy storage compositions of the present disclosure also include a polymer, such as a thermoplastic polymer.

As set forth in more detail herein, the energy storage compositions of the present disclosure can have numerous variations. For instance, various types of clays, ionic liquids, salts (e.g., lithium salts) and polymers may be utilized to make various types of energy storage compositions. Furthermore, the energy storage compositions of the present disclosure may be used as thermally and mechanically stable electrolytes in various types of energy storage devices.

Clays

Various types of clays may be utilized in the energy storage compositions of the present disclosure. Clays generally refer to artificially or naturally occurring hydrated aluminum silicates. In some embodiments, the clays can include one or more minerals. In some embodiments, the minerals include, without limitation, silicon, aluminum, iron, magnesium, and combinations thereof. In some embodiments, the clays are in the form of microparticles or nanoparticles.

In some embodiments, the clays in the energy storage compositions of the present disclosure include, without limitation, bentonite clay, montmorillonite clay, kaolinite clay, tonstein clay, laponite clay, and combinations thereof. The use of additional clays in the energy storage compositions of the present disclosure can also be envisioned.

In some embodiments, the clays in the energy storage compositions of the present disclosure appear as layered structures. In some embodiments, the layers of clay in the energy storage compositions of the present disclosure are intercalated by organic molecules or ionic liquids.

Ionic Liquids

Various types of ionic liquids may also be utilized in the energy storage compositions of the present disclosure. Ionic liquids generally refer to salts that are in a liquid state.

Ionic liquids have been widely studied as electrolytes for energy storage devices. Although they possess relatively low ionic conductivity values at room temperature, they usually present high electrochemical stability. As a consequence, ionic liquids can be part of devices operating at wide potential windows, thereby raising the final energy density.

When the melting point of an ionic liquid is below room temperature, the ionic liquid can also be referred to as a room temperature ionic liquid (RTIL). In some embodiments, the ionic liquids in the energy storage compositions of the present disclosure include a room temperature ionic liquid (RTIL).

In some embodiments, RTILs are ionic compounds with two bulky counter ions that can efficiently disperse the charge over the entire ion. In some embodiments, RTILs may have compositions (e.g., compositions containing organic fragments) that limit their thermal stability to around 300° C. However, the ionic nature of the RTILs can allow them to present negligible vapor pressure over their entire range of thermal stability.

In some embodiments, the ionic liquids in the energy storage compositions of the present disclosure include a cationic component and an anionic component. In some embodiments, the cationic component of the ionic liquid includes, without limitation sulfonium-based structures, imidazolium-based structures, pyridinium-based structures, piperidinium-based structures, pyrrolidinium-based structures, pyrazolium-based structures, ammonium-based structures, phosphonium-based structures, and combinations thereof. In some embodiments, the anionic component of the ionic liquids in the energy storage compositions of the present disclosure includes, without limitation, bis(trifluoromethylsulfonyl)imide, hexafluorophosphate, methanesulfanate, triflate, tetrafluoroborate, and combinations thereof.

In some embodiments, the ionic liquids in the energy storage compositions of the present disclosure comprise a room temperature ionic liquid (RTIL). In some embodiments, the ionic liquids in the energy storage compositions of the present disclosure include, without limitation, 1-Butyl-2,3-dimethylimidazolium bis(trifluoromethylsulfonyl)imide (BMMI-TFSI), 1-Butyl-1-methylpiperidinium bis(trifluoromethylsulfonyl)imide, 1-Butyl-3-methylimidazolium hexafluorophosphate, 1-Butyl-3-methylimidazolium tetrafluoroborate, 1-Methyl-1-propylpiperidinium bis(trifluoromethylsulfonyl)imide, 1-Butyl-1-methylpiperidinium bis(trifluoromethylsulfonyl)imide (PP-TFSI), Diethylmethylsulfonium bis(trifluoromethylsulfonyl)imide, N,N-diethyl-N-methyl-N-(2-methoxyethyl)ammonium bis(trifluoromethylsulfonyl)imide, and combinations thereof.

In some embodiments, the ionic liquids of the present disclosure also include a salt or a combination of salts. In some embodiments, the salt or combination of salts are dissolved in the ionic liquid.

In some embodiments, the salt dissolved in the ionic liquid includes a lithium-containing salt. In some embodiments, the lithium-containing salt includes, without limitation, Lithium bis(trifluoromethylsulfonyl)imide, Lithium Hexafluorophosphate, Lithium Tetrafluoroborate, Lithium bis(oxalate)borate (LiBOB), and combinations thereof.

In some embodiments, the total concentration of salts dissolved in the ionic liquid includes, without limitation, 0.2 mol L⁻¹, 0.5 mol L⁻¹, 0.8 mol L⁻¹ and 1 mol L⁻¹. In some embodiments the total concentration of salts dissolved in the ionic liquid is 1 mol L⁻¹. In more specific embodiments, the salt dissolved in the ionic liquid includes a lithium-containing salt at a concentration of 1 mol L⁻¹.

In some embodiments, the ionic liquids in the energy storage compositions of the present disclosure include BMMI-TFSI. In some embodiments, the ionic liquids in the energy storage compositions of the present disclosure include PP-LTFSI. The use of additional ionic liquids in the energy storage compositions of the present disclosure can also be envisioned.

The ionic liquids and clays in the energy storage compositions of the present disclosure can be present in various ratios. For instance, in some embodiments, the clay and the ionic liquid (with or without one or more salts dissolved in the ionic liquid) are present in the energy storage composition in a weight ratio of 1:1. In some embodiments, the clay and the ionic liquid are present in the energy storage composition in clay to ionic liquid weight ratios of 1:2, 1:5, 1:10, 2:1, 5:1, or 10:1. The use of additional clay to ionic liquid weight ratios in the energy storage compositions of the present disclosure can also be envisioned.

Polymers

In various embodiments, the energy storage compositions of the present disclosure also include one or more polymers. In some embodiments, the polymer includes a thermoplastic polymer. In some embodiments, the thermoplastic polymer includes, without limitation, polyurethanes, polyacrylates, polyamides, polyimides, polyimidazoles, polystyrene, poly(vinyl chloride), poly (vinylidene difluoride), and combinations thereof.

In some embodiments, the polymer in the energy storage compositions of the present disclosure includes thermoplastic polyurethane (TPU). In some embodiments, the polymer in the energy storage compositions of the present disclosure include, without limitation, poly(vinylidene difluoride) (PVdF), polyimides, polyethylene, polypropylenes, and combinations thereof. The use of additional polymers in the energy storage compositions of the present disclosure can also be envisioned.

The energy storage compositions of the present disclosure can include various amounts of one or more polymers. For instance, in some embodiments, the polymer content in the energy storage compositions of the present disclosure can vary from about 1% to about 50% by weight of the energy storage compositions. In some embodiments, the polymer content in the energy storage compositions of the present disclosure can vary from about 5% to about 25% by weight of the energy storage compositions. In some embodiments, the polymer content in the energy storage compositions of the present disclosure is about 10% by weight of the energy storage composition. In more specific embodiments, the energy storage compositions of the present disclosure include a thermoplastic polymer (e.g., TPU) that constitutes about 10% by weight of the energy storage composition. Additional amounts of polymers in the energy storage compositions of the present disclosure can also be envisioned.

Structures

The energy storage compositions of the present disclosure may be in various forms. In some embodiments, the energy storage compositions of the present disclosure may be in liquid form. In some embodiments, the energy storage compositions of the present disclosure may be in solid form. In some embodiments, the energy storage compositions of the present disclosure may be in a paste form. In some embodiments, the energy storage compositions of the present disclosure may be in homogenous form. In some embodiments, the energy storage compositions of the present disclosure may be in heterogeneous form.

In some embodiments, the energy storage compositions of the present disclosure may be in the form of a film, such as a thin film. In some embodiments, the energy storage compositions of the present disclosure may be freestanding. In some embodiments, the freestanding energy storage compositions of the present disclosure may be cut into different shapes and sizes.

Relation to Energy Storage Devices

In some embodiments, the energy storage compositions of the present disclosure may be associated with various types of energy storage devices or their individual components (e.g., electrodes of energy storage devices). For instance, in some embodiments, the energy storage compositions of the present disclosure may be employed in, assembled in, contained in, or combined with various energy storage devices or their individual components. In some embodiments, the energy storage devices that are associated with the energy storage compositions of the present disclosure may include, without limitation, batteries (e.g., lithium-ion batteries) and capacitors (e.g., supercapacitors).

In some embodiments, the energy storage compositions of the present disclosure serve as electrolytes and separator in energy storage devices (e.g., capacitors and batteries). In some embodiments, the energy storage compositions of the present disclosure operate as electrolytes and separator in energy storage devices at high temperatures. In some embodiments, the high temperatures can include, without limitation, up to 120° C., up to 200° C., or up to 300° C.

In some embodiments, the energy storage compositions of the present disclosure may be associated with (e.g., combined with) various components of an energy storage device. For instance, in some embodiments, the energy storage compositions of the present disclosure may be associated with (e.g., combined with) separators, electrodes, current collectors, electrode-electrolyte assemblies, electrode-electrolyte-spacer assemblies, and combinations thereof.

In some embodiments, the energy storage compositions of the present disclosure are associated with (e.g., combined with) electrodes for an energy storage device. In some embodiments, the electrodes associated with (e.g., combined with) the energy storage compositions of the present disclosure may include an inorganic oxide, a conductive carbon material, and combinations thereof.

In some embodiments, the conductive carbon material may include, without limitation, graphite, graphene oxide (GO), reduced graphene oxide (RGO), activated carbon (AC), carbon nanotubes, and combinations thereof. In some embodiments, the conductive carbon material may include reduced graphene oxide (RGO). In some embodiments, the conductive carbon material may include single-wall carbon nanotubes.

In some embodiments, the inorganic oxide is capable of reversibly reacting with lithium ions. In some embodiments, the inorganic oxide includes, without limitation, Lithium Titanate (LTO, Li₄Ti₅O₁₂), Lithium Cobalt (III) Oxide (LCO, LiCoO₂), Lithium Nickel Manganese Cobalt Oxide, Lithium Iron (II) Phosphate, Lithium Nickel Oxide, Vanadium Oxide, and combinations thereof.

In some embodiments, the inorganic oxide or the conductive carbon material in electrodes may be mixed with a conductive filler, a binder, or combinations thereof. In some embodiments, the conductive filler includes, without limitation, graphite, carbon black and combinations thereof. In some embodiments the binder includes, without limitation, polyvinylidene difluoride (PVdF).

In some embodiments, the energy storage compositions of the present disclosure are coated directly onto an electrode. The association of the energy storage compositions of the present disclosure with additional electrodes can also be envisioned.

In some embodiments, the energy storage compositions of the present disclosure are associated with a separator for an energy storage device. In some embodiments, the separator includes, without limitation, cellulose papers, cellophane fabrics, polymers, asbestos, glass wool, and combinations thereof.

In more specific embodiments, the energy storage compositions of the present disclosure are components of an electrode-separator-electrolyte assembly for an energy storage device. In some embodiments, the energy storage compositions of the present disclosure are coated directly onto an electrode to achieve electrode-separator-electrolyte assemblies as building blocks for energy storage devices.

In some embodiments, the energy storage compositions of the present disclosure may be used in electrochemical capacitors or in lithium-ion batteries with electrodes (e.g., RGO electrodes) and a separator. In some embodiments, the energy storage compositions of the present disclosure may be used in electrochemical capacitors or in lithium-ion batteries with electrodes (e.g., RGO electrodes) but no additional separators. In some embodiments the fabricated devices that contain the energy storage compositions of the present disclosure may be assembled both in series and in parallel in a circuit to provide the required energy and power.

Fabrication

Various methods may be utilized to make the energy storage compositions of the present disclosure. In some embodiments, the methods of making the energy storage compositions of the present disclosure can include the selection of appropriate ionic liquids. In some embodiments, ionic liquids are selected such that their cation size is compatible to the interlayer spacing present in a clay (e.g., bentonite clay). In some embodiments, the methods of making the energy storage compositions of the present disclosure can also include optimization of weight ratios of the clay (e.g., Bentonite clay) and ionic liquids (e.g., RTIL) for uniform dispersion and temperature stability. In some embodiments, the methods of making the energy storage compositions of the present disclosure can also include investigation of ionic conductivity, mechanical resistance and temperature stability of the formed energy storage compositions. In further embodiments, a lithium-containing salt (e.g., LiTFSI) is dissolved in the ionic liquid.

Applications and Advantages

The energy storage compositions of the present disclosure can have various advantageous attributes. For instance, as set forth previously, the energy storage compositions of the present disclosure can be operable within energy storage devices at high temperatures (e.g., up to 120° C., 200° C. or 300° C.) and over wide electrochemical windows.

Furthermore, various components of the energy storage compositions of the present disclosure have natural abundance, low cost, and non-toxicity. As such, the energy storage compositions of the present disclosure can be manufactured in a cost effective and environmentally friendly manner.

Therefore, as set forth previously, the energy storage compositions of the present disclosure can be used as components of various energy storage devices. For instance, in some embodiments, the energy storage compositions of the present disclosure can be used as thermally stable electrolytes for high temperature energy storage devices. In some embodiments, the energy storage compositions of the present disclosure are thermally and mechanically stable at temperatures above 120° C. In some embodiments, the energy storage compositions of the present disclosure are thermally and mechanically stable at temperatures above 200° C. In some embodiments, the energy storage compositions of the present disclosure are thermally and mechanically stable at temperatures above 300° C.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1

### High Temperature Composite Electrolytes for Supercapacitors

In this Example, operating temperatures up to 200° C. are demonstrated for a supercapacitor device that contains an energy storage composition of the present disclosure as an electrolyte. The energy storage compositions in this Example include naturally occurring clays that are combined with room temperature ionic liquids (RTIL) (also referred to as clay-based energy storage compositions). Applicants demonstrate in this Example that the clay-based energy storage compositions can perform the role of electrolytes and separators with optimal thermal and mechanical stability and ionic conductivity. Applicants also demonstrate in this Example that the clay-based energy storage compositions can facilitate operation of energy storage devices (e.g., supercapacitor devices) at temperatures as high as 200° C. Furthermore, Applicants demonstrate in this Example that the addition of 10% (by weight) of thermoplastic polyurethane (TPU) to the clay-based energy storage compositions allowed the production of a freestanding, membrane-like electrolyte.

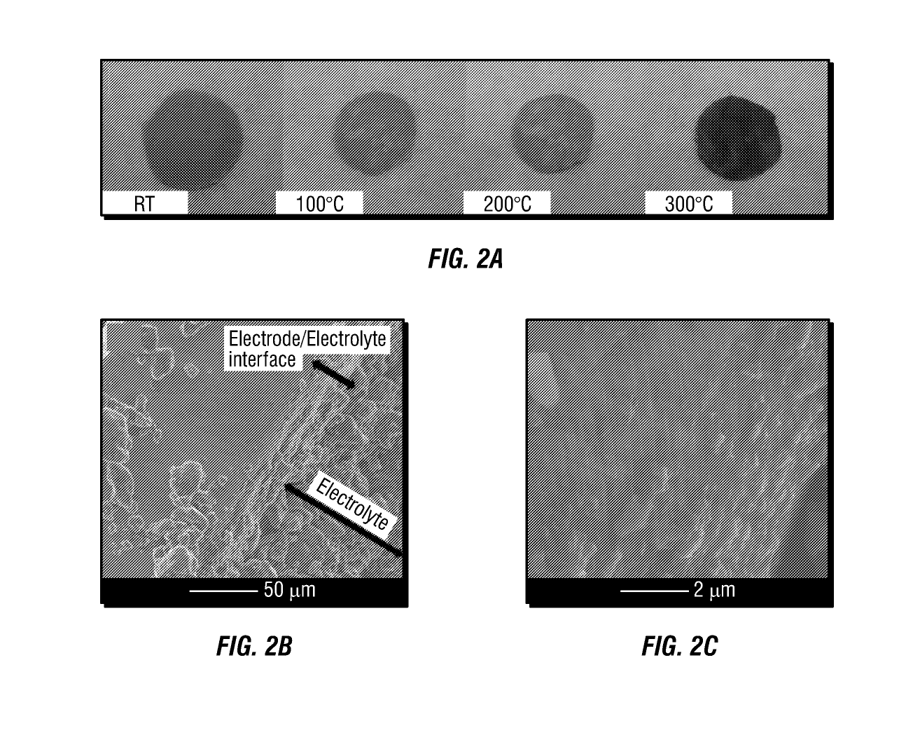

FIG. 2A shows the optical pictures of clay-based energy storage compositions that contain Bentonite clay and the RTIL, 1-Butyl-2,3-dimethylimidazolium bis(trifluoromethylsulfonyl)imide (referred to in this Example as BMMI-TFSI or RTIL). The optical pictures are shown after treatment of the clay-based compositions at different temperatures. Photos were taken one hour after the sample reached the indicated temperature. The observation of no visual changes with increasing temperature (e.g., up to 200° C.) indicated that this clay-based energy storage composition can be used in high temperature energy storage devices.

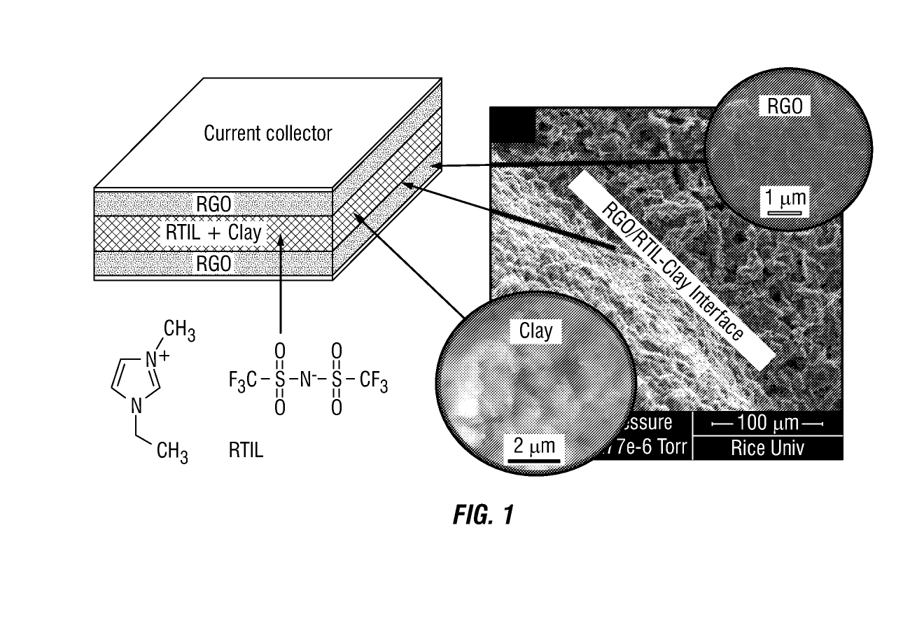

Without being bound by theory, it is envisioned that the exchangeable cations between the layers of clay (e.g., Bentonite clay) in clay-based energy storage compositions can be mobilized using RTILs, such as BMMI-TFSI. See, e.g., FIG. 1. Similar observations were noted in some reports where small cations between layers of clay were replaced by different ions to improve composite properties because of the increase of matrix-filler compatibility. However, in the present Example, the mechanical process of the RTIL-clay mixture used to prepare the electrolyte was designed just to obtain a homogeneous composition without increasing temperature or conducting a chemical reaction. The objective in this Example was to use the ionic liquid ions as charge carriers, requiring that the ions remain as free as possible. An efficient adhesion was also attained in the interface between the electrode and the electrolyte, as shown in FIG. 1B.

In a supercapacitor device, the clay-based energy storage compositions of this Example served as electrolytes and separators. The clay-based energy storage compositions of this Example also provided ions to electrodes made of materials such as reduced graphene oxide (RGO), used for making a symmetric device.

FIGS. 2B and 2C shows scanning electron microscopy (SEM) images of a RGO electrode coated with the clay-based energy storage composition (containing Bentonite clay and BMMI-TFSI) that serves as an electrolyte and separator. The SEM images show the existence of good surface adhesion between the electrode and the electrolyte coating.

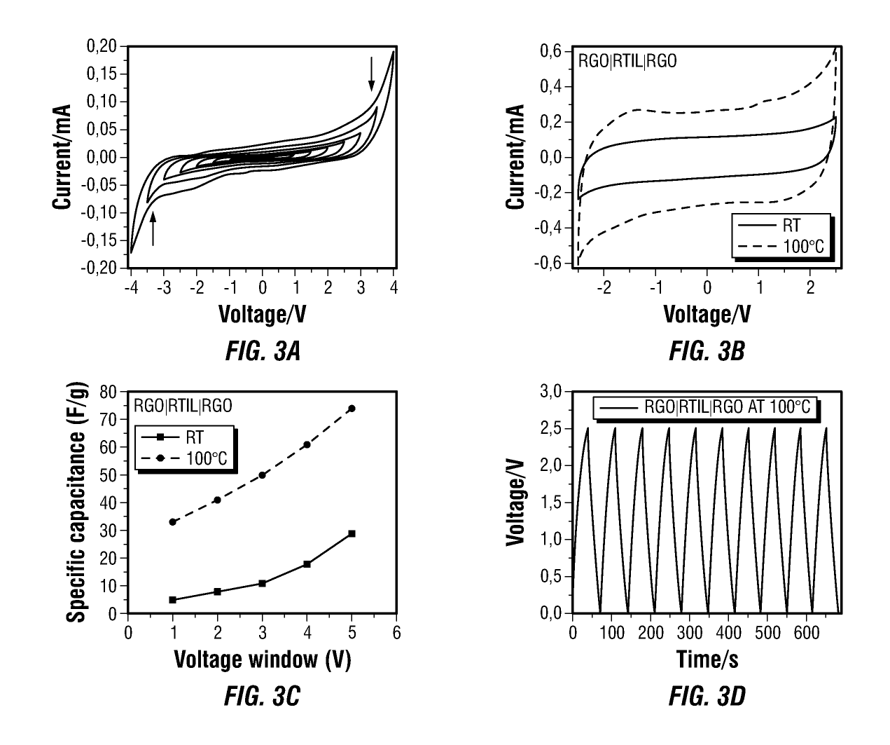

BMMI-TFSI was chosen as an RTIL for this Example due its thermal and electrochemical stability, as well as a good ionic conductivity. Electrochemical and thermal properties of BMMI-TFSI were evaluated for validation. The absence of any noticeable electrochemical reduction and oxidation reactions between −3.0 V to +3.0 V from the cyclic voltammetry measurement seen in FIG. 3A indicates that BMMI-TFSI can be successfully employed for 6V electrochemical window applications. This result is in agreement with previous reports.

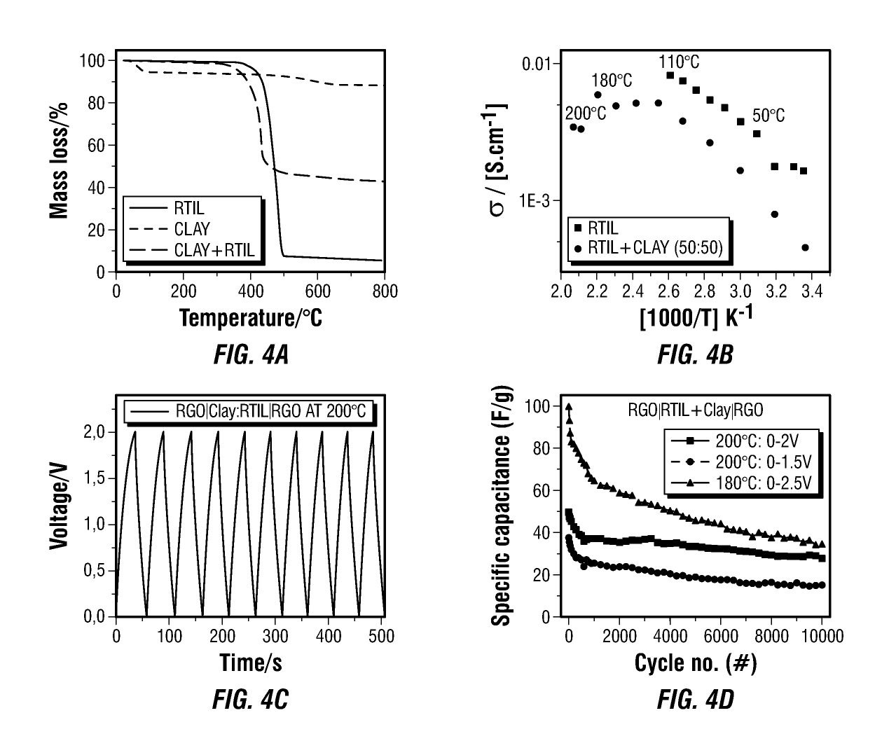

Ionic conductivity as a function of temperature was studied by conducting electrochemical impedance spectroscopy measurements from room temperature to 100° C. Ionic conductivity of BMMI-TFSI was in the order of mS/cm and increased with increasing temperature. See FIG. 4B. The value of conductivity and the trend with temperature is close to other works in the literature.

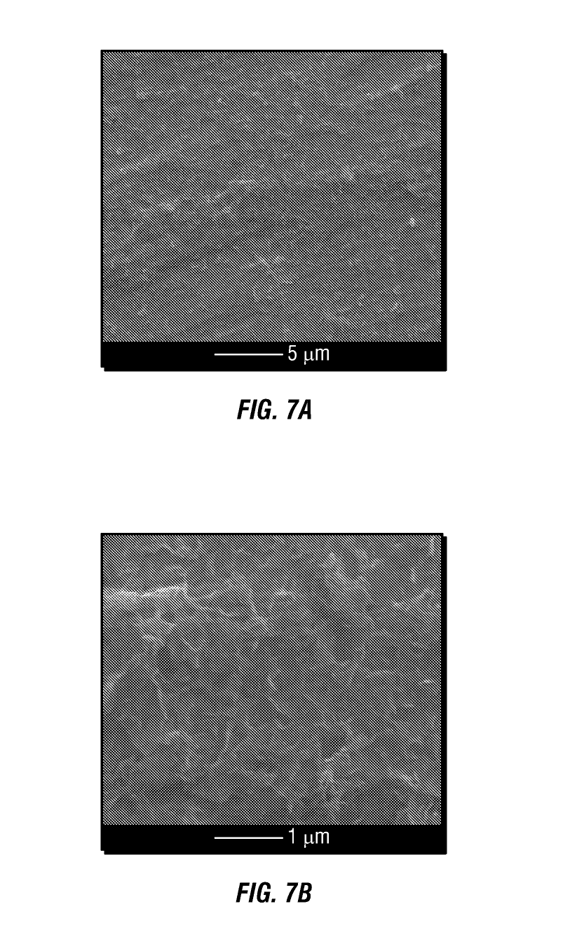

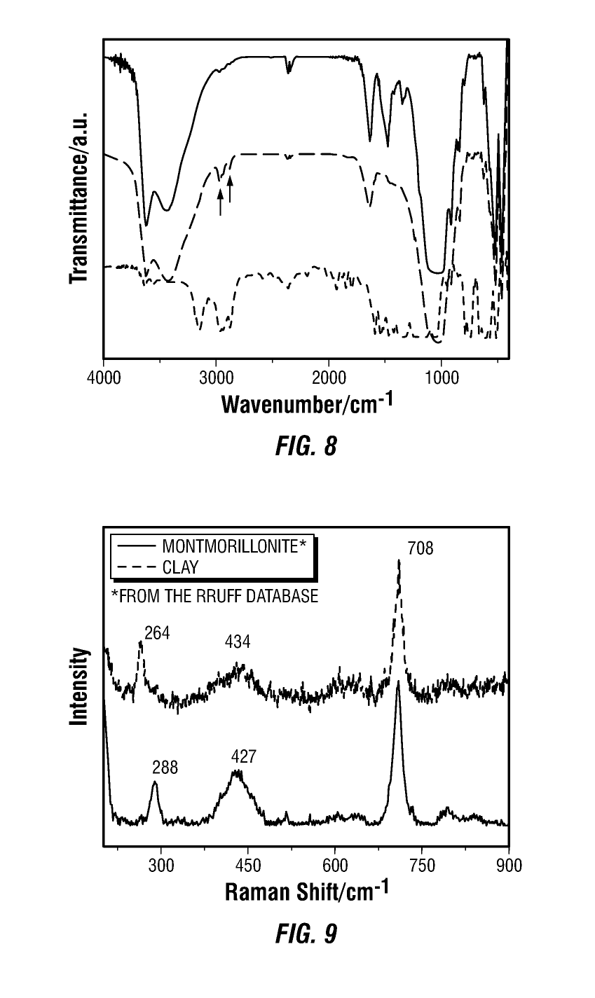

A supercapacitor test cell was fabricated using BMMI-TFSI as an electrolyte, a celgard membrane as a separator (˜20 μm thick), and RGO as electrodes. RGO was obtained by chemical reduction of graphene oxide (GO). The quality of the reduction was characterized using thermogravimetric measurements (TG). The morphology of the RGO electrodes was observed by SEM. See FIG. 7.

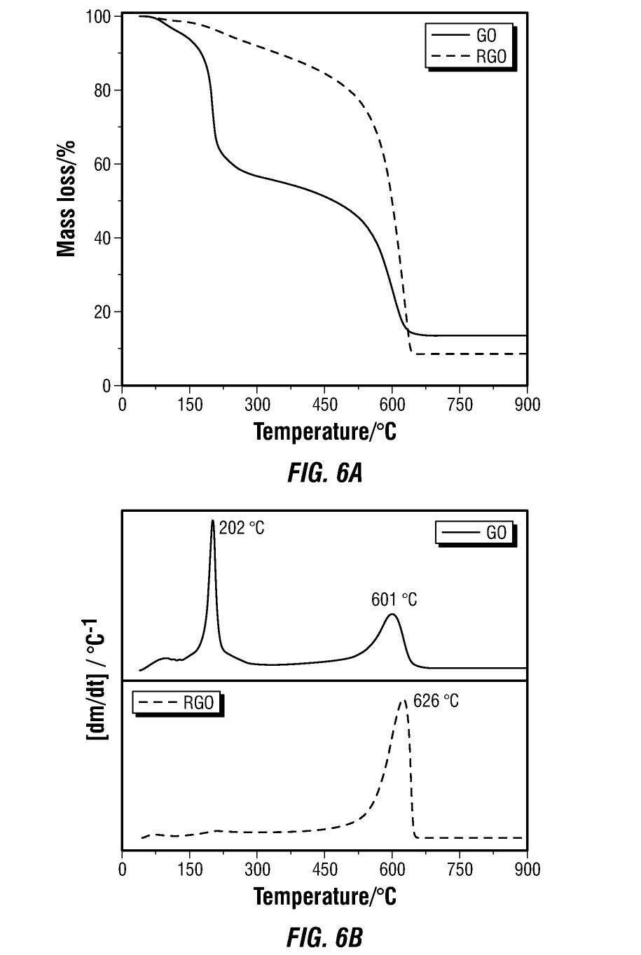

A high reduction degree was observed for RGO. The mass loss attributed to functional groups reduced 80% in comparison with the GO content of functional groups (FIG. 6A). The nearly absence of degradation of functional groups on the reduced sample can be even more clearly observed in the plot of the derivative of TG curve in respect to temperature, shown in FIG. 6B. SEM micrographs (FIG. 7) showed that RGO sheets completely covered the current collector surface.

The electrochemical properties of the supercapacitor test cells were investigated by cyclic voltammetry (CV) and galvanostatic charge-discharge (CD) measurements. Recorded cyclic voltammograms at different temperatures (Room temperature and 100° C.) are shown in FIG. 3B. The voltammograms, obtained using a scan rate of 60 mV s⁻¹, presented rectangular profiles that were symmetric in anodic and cathodic directions at both temperatures. The increase in the area of the CV curve with an increase in temperature indicates an enhancement in the specific capacitance. This enhancement can be attributed to a most effective utilization of the electrode material by an electrolyte, as a consequence of the improved ionic conductivity of the electrolyte.

Different voltage windows were used to measure cyclic voltammetry of the supercapacitor test cells. Specific capacitance values as a function of the voltage window is shown in FIG. 3C. Specific capacitance reaches values greater than 70 F/g when the capacitor works at 100° C. at 5 V.

Next, galvanostatic charge-discharge measurements were conducted on the supercapacitor test cells at room temperature and 100° C. The resultant profile of voltage as a function of time for the test cells at 100° C. is shown in FIG. 3D. Such results are in agreement with results of the literature that utilize ionic liquids as electrolytes. However, such results present lower capacitance than other reports that use the addition of solvent to decrease the viscosity of the ionic liquid, thereby increasing ionic conductivity and improving ionic accessibility to the porous structure of the electrodes.

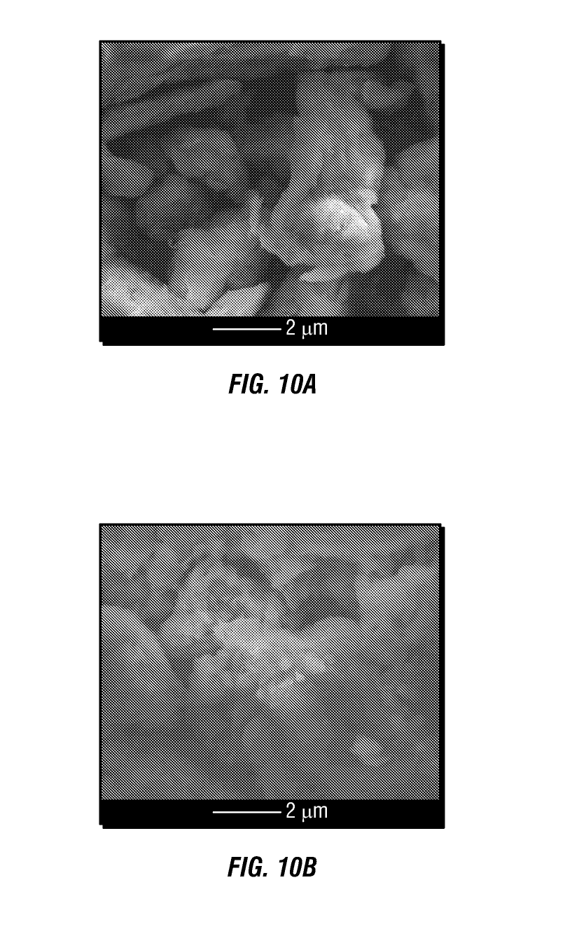

Applicants observed that supercapacitors with RTIL (i.e., BMMI-TFSI) electrolytes and celgard or conventional separators could not withstand temperatures higher than 100° C. for a long time while keeping up the electrochemical performance. For better thermal stability, naturally occurring Bentonite clay (from Southern Clay Products) was mixed with the RTIL and the final mixture was used as a separator/electrolyte composite. FIGS. 9-11 provide results pertaining to the characterization of the clay and the clay:RTIL materials.

The optimum composition of the clay:RTIL mixture was deduced by measuring the temperature and mechanical stability of the composite and its ionic conductivity at various ratios of clay to BMMI-TFSI. A 1:1 (w/w) ratio of clay and BMMI-TFSI was observed to have the best performance. To confirm the thermal stability of the composite, thermogravimetric measurements were conducted on clay alone, RTIL alone and 1:1 (w/w) of clay:RTIL composite. The results are shown in FIG. 4A. The results show that the clay:RTIL composites can withstand temperatures as high as 300° C. without any significant mass degradation in air.

Further, in order to understand the effect of temperature on ionic conductivities of clay:RTIL composites, impedance spectroscopy measurements were conducted at various temperatures. The ionic conductivity of the composite increases almost linearly until 180° C. and then saturates at 200° C. The results are shown in FIG. 4B. For comparison, ionic conductivity of pristine RTIL is also shown along with clay:RTIL composites. Without being bound by theory, it is envisioned that the slight decrease in ionic conductivity of clay:RTIL composites compared to pristine RTIL at all temperatures can be attributed to the higher viscosity induced by clay.

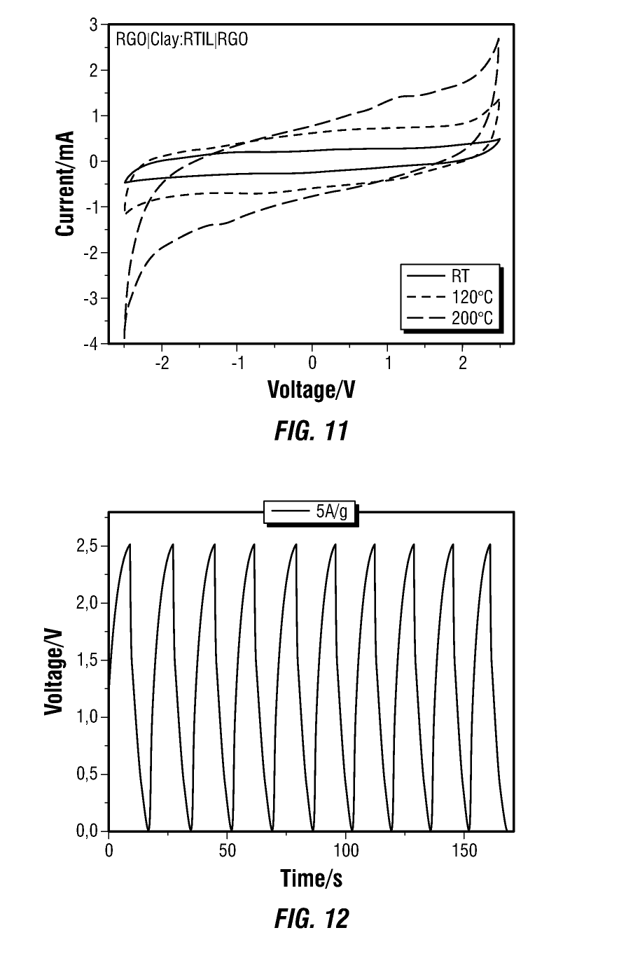

Having confirmed that the above clay:RTIL composites can survive temperatures as high as 200° C. without compromising the ionic conductivity, supercapacitor devices were fabricated using this composite membrane as the electrolyte/separator. A supercapacitor device with symmetric electrodes was made in the following configuration: RGO/clay:RTIL/RGO. The performance of the device was tested by conducting cyclic voltammograms and galvanostatic charge-discharge measurements at different temperatures (room temperature, 120° C., 180° C. and 200° C.) and different potential windows. The observed stable cyclic voltammograms at 200° C. indicate the successful formation of double layers on the electrodes without any electrical short circuit (see FIG. 11).

The above-mentioned supercapacitor device can be operated up to a 2.5 V positive potential without exhibiting significant pseudo-capacitance or electrolyte degradation. The stability of the device over prolonged cycling has been verified by conducting Galvanostatic charge-discharge measurements at 200° C. The resultant voltage vs time curve for 2.0 V electrochemical window is shown in FIG. 4C. Specific capacitance vs cycle number plots extracted from this data are presented in FIG. 4D. It is seen that, although there is a slight drop during the initial cycles, the device has a stable specific capacitance of 20 F/g, 40 F/g and 50 F/g between 0-1.5V, 0-2V, and 0-2.5V, respectively, even after 10,000 cycles of charge-discharge. The observed initial drop in the specific capacitance can be attributed to irreversible solid electrolyte interface reactions, a commonly observed phenomenon.

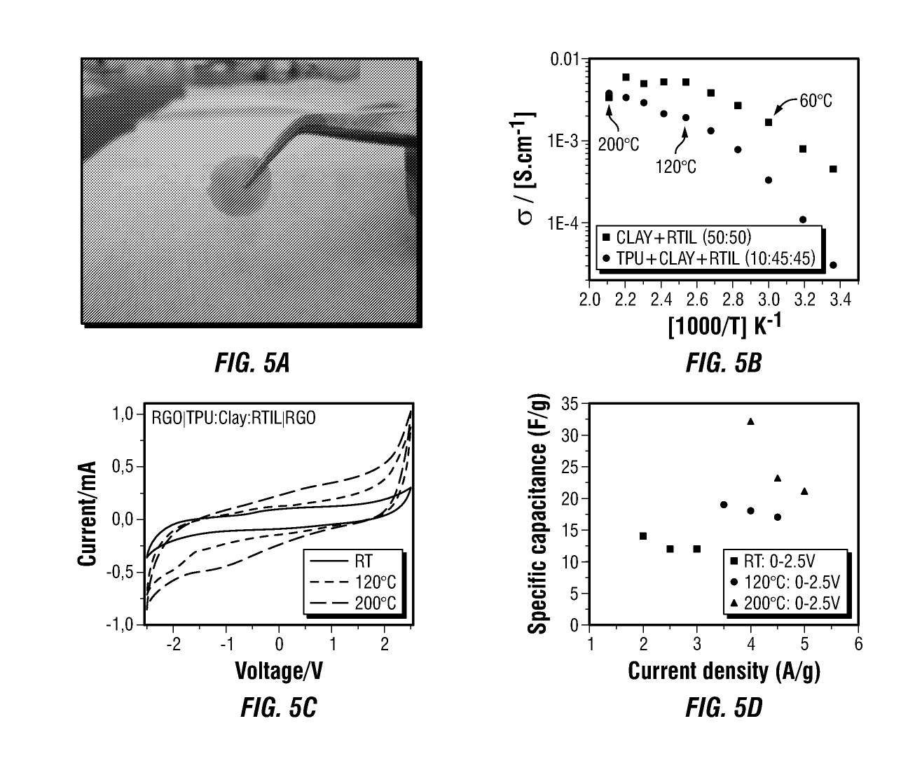

The results above indicate that the clay:RTIL composites are an optimal electrolyte system for high temperature energy storage devices. In order to increase the versatility of such composites, it would be more convenient to have a free standing film which can be cut into different shapes and sizes. Applicants added 10% (by weight) of Themoplastic polyurethane (TPU) to the clay:RTIL mixture, by a solution process employing tetrahydrofuran as solvent. The composition was then cast into a film and peeled out to form a freestanding film, as shown in FIG. 5A. Ionic conductivity values of this membrane (TPU:Clay:RTIL) as a function of temperature were extracted from electrochemical impedance measurements and the results are shown in FIG. 5B. The membrane is seen to have optimal conductivity at higher temperatures (e.g., about two orders more at 200° C.) than at room temperature.

The addition of polymer to the clay:RTIL mixture reduces the conductivity of the mixture at room temperature. However, as observed in FIG. 5B, such loss should not be as detrimental to its performance at higher temperatures.

Next, Applicants fabricated a supercapacitor device using RGO electrodes and the above TPU:clay:RTIL membrane. Applicants then studied the supercapacitor device's electrochemical properties. Recorded CVs at different temperatures over a 5.0 V electrochemical window for the supercapacitor device are shown in FIG. 5C. Again, the increase in area under CV curves indicates the enhanced capacitance at higher temperatures.

Galvanostatic charge-discharge measurements were also conducted on the above supercapacitor device at different temperatures, different potential widows, and different current densities. A charge-discharge curve at 200° C. and 2.5V is shown in FIG. 12. FIG. 5D summarizes the effect of temperature, potential window and applied current rates on the specific capacitance of the above supercapacitor device. A maximum specific capacitance of 33 F/g has been observed at 200° C. for this supercapacitor device. At any constant temperature, a slight decrease in specific capacitance is observed with an increase in current rates. However, the specific capacitance of the supercapacitor increases with an increase in temperature and an increase in electrochemical potential window.

To summarize, a high temperature electrochemical energy storage concept is demonstrated in this Example. A new composite electrolyte membrane was developed that can withstand temperatures up to 200° C. The performance of the composite electrolyte was demonstrated in supercapacitor devices. The high temperature supercapacitor devices built using RGO electrodes and clay:RTIL membrane electrolytes show nearly a double increase in the operational temperature range when compared to existing devices. The present disclosure can provide solutions for several high temperature energy storage problems and could be useful in energy storage and energy conversion applications.

### Example 1.1

### Characterization of BMMI-TFSI

The room temperature ionic liquid, BMMI-TFSI was obtained from Iolitec. According to the supplier, BMMI-TFSI presents a 99% purity and a water content of less than 100 ppm. BMMI-TFSI was handled in a glove box (Unilab MBraun) under argon atmosphere. The glove box had a water level of less than 0.1 ppm and an oxygen level of less than 10 ppm.

Electrochemical properties of BMMI-TFSI were measured by cyclic voltammetry and electrochemical impedance spectroscopy (EIS). Electrical measurements were performed in an AUTOLAB PGSTAT 302N ECOCHEMIE frequency analyzer. Cyclic voltammetry measurements were performed in different potential windows ranging from 1 V to 8 V with a scan rate of 50 mV s⁻¹. A stainless steel current collector was used. EIS experiments were conducted using a frequency range from 0.5 MHz to 0.5 Hz at 0V with an amplitude of 10 mV. Thermal stability of BMMI-TFSI was obtained by thermogravimetric (TG) measurements performed in a TA Instruments SDT 2960 in air atmosphere at a heating rate of 10° C. min⁻¹. Approximately 15 mg of BMMI-TFSI was used in TG measurements.

### Example 1.2

### Characterization of Bentonite Clay

Bentonite clay was obtained from Southern Clay Products. According to the supplier, the obtained clay has a purity of 99%. The chemical structure of the clay was analyzed by Infrared and Raman measurements. The FTIR spectrum was made in a Perkin-Elmer BX spectrometer in Transmission mode. The sample was first dispersed in KBr and compressed to a compact pellet. The spectrum was acquired after 64 scans with a 4 cm⁻¹ resolution. Micro-Raman experiments were made in a DILOR XY spectrometer using an OLYMPUS BH-2 optical microscope with a 100× objective. Excitation at 514.5 nm with 3 mW of power was provided by an Ar-Kr laser. X-Ray diffraction (XRD) measurements were conducted in a Siemens-D5000 diffractometer using a copper tube and a scan rate of 4° min⁻¹. The morphology of bentonite clay was observed by scanning electron microscopy (SEM). Images were obtained in a FEI QUANTA 200® scanning electron microscope using secondary electrons without any cover over the samples. Thermal properties of bentonite clay were obtained by thermogravimetric (TG) measurements performed in a TA Instruments SDT 2960 in air atmosphere at a heating rate of 10° C. min⁻¹. Approximately 15 mg of bentonite clay was used in TG measurements.

### Example 1.3

### Fabrication and Characterization of Clay:RTIL Electrolytes

The new composite electrolyte based on bentonite clay and the RTIL BMMI-TFSI was prepared by mixing an appropriate ratio of each material using a mortar until a homogenous paste like mixture was obtained. The mixture (also referred to as an electrolyte or a composite) was spread onto a stain steel current collector in order to perform electrochemical measurements, cyclic voltammetry and electrochemical impedance spectroscopy (EIS). Electrical measurements were performed in an AUTOLAB PGSTAT 302N ECOCHEMIE frequency analyzer. Cyclic voltammetry measurements were performed in different potential windows ranging from 1 V to 7 V with a scan rate of 50 mV s⁻¹. EIS experiments were conducted using a frequency range from 0.5 MHz to 0.5 Hz at 0V with amplitude of 10 mV. Thermogravimetric (TG) measurement of clay:RTIL electrolyte was performed in a TA Instruments SDT 2960 in air atmosphere at a heating rate of 10° C. min⁻¹. Approximately 15 mg of composite was analyzed by TG measurements.

The chemical structure of washed clay:RTIL composite was analyzed by Infrared spectroscopy. The composite was prepared as described above and then washed at least ten times using distilled water to eliminate the RTIL that was adsorbed in excess on the clay structure. The sample was dried at 100° C. for several hours and then dispersed in KBr and finally compressed to a compact pellet. The FTIR spectrum was made in a Perkin-Elmer BX spectrometer in Transmission mode. The spectrum was acquired after 64 scans with a 4 cm⁻¹ resolution. The morphology of clay:RTIL was observed by scanning electron microscopy (SEM). Images were obtained in a FEI QUANTA 200® scanning electron microscope using secondary electrons without any cover over the samples.

### Example 1.4

### Fabrication and Characterization of TPU:Clay:RTIL Electrolytes

A new electrolyte membrane based on a thermoplastic polyurethane (TPU, Irogran PS455-203 from Huntsman), bentonite clay and RTIL was prepared by mixing the previously-prepared clay:RTIL electrolyte with 10 wt. % of polyurethane dissolved in tetrahydrofuran (THF). This electrolyte solution was coated on a stainless steel current collector in order to evaporate the solvent and obtain an electrolyte film. The electrochemical performance was measured by electrochemical impedance spectroscopy (EIS). Electrical measurements were performed in an AUTOLAB PGSTAT 302N ECOCHEMIE frequency analyzer. EIS experiments were conducted using a frequency range from 0.5 MHz to 0.5 Hz at 0V with amplitude of 10 mV.

### Example 1.5

### Fabrication and Characterization of RGO Electrodes

Reduced graphene oxide (RGO) powder was obtained from a hydrazine reaction using graphene oxide (GO) powder as precursor. GO was synthesized using an Improved Hummer Method from a commercial graphite (Bay Carbon). Thermogravimetric (TG) measurements of GO and RGO were performed in a TA Instruments SDT 2960 in air atmosphere at a heating rate of 5° C. min⁻¹. Approximately 10 mg of sample was used in TG measurements. RGO ink was prepared in 2-propanol using ultrasonic bath for several hours until a stable dispersion was obtained. The electrodes were prepared by drop casting of consecutive layers of RGO dispersion onto a stainless steel current collector. The morphology of RGO electrodes was analyzed by scanning electron microscopy (SEM). Images were obtained in a FEI QUANTA 200® scanning electron microscope using secondary electrons without any cover over the samples.

### Example 1.6

### Fabrication and Characterization of Supercapacitors

Electrochemical capacitors were prepared in a stacked configuration with two RGO electrodes (prepared directly on stainless steel current collectors) with an RTIL layer in-between as an electrolyte. A celgard separator was used to support the ionic liquid. Electrochemical properties of capacitors were measured by cyclic voltammetry (CV), electrochemical impedance spectroscopy (EIS) and galvanostatic charge-discharge measurements. Electrical measurements were performed in an AUTOLAB PGSTAT 302N ECOCHEMIE frequency analyzer. CV measurements were performed in different potential windows ranging from 1 V to 4 V with a scan rate of 60 mV s⁻¹. EIS experiments were conducted using a frequency range from 1 MHz to 0.1 Hz at 0V with amplitude of 10 mV. Galvanostatic charge-discharge measurements were obtained at a 2.5V voltage window by using different current densities.

### Example 1.7

### Fabrication and Characterization of High Temperature Supercapacitors by Using Clay:RTIL and Clay:RTIL:TPU as Electrolytes

Electrochemical capacitors were prepared in a stacked configuration with two RGO electrodes (prepared directly on stainless steel current collectors). A layer of a clay:RTIL composite electrolyte or a clay:RTIL:TPU (10 wt. %) electrolyte was spread out in-between RGO electrodes. No separator was necessary in that capacitor configuration. Electrochemical properties of capacitors were measured by cyclic voltammetry (CV), electrochemical impedance spectroscopy (EIS) and galvanostatic charge-discharge measurements. Electrical measurements were performed in an AUTOLAB PGSTAT 302N ECOCHEMIE frequency analyzer at several temperatures, being 200° C. the highest. CV measurements were performed in different potential windows ranging from 1 V to 4 V with a scan rate of 60 mV s⁻¹. EIS experiments were conducted using a frequency range from 1 MHz to 0.1 Hz at 0V with amplitude of 10 mV. Galvanostatic charge-discharge measurements were obtained at voltage windows of 1.5V, 2.0V and 2.5V. Different current densities were used for clay:RTIL based capacitors.

### Example 2

### Development of Activated Carbon (AC) and Single-Wall Carbon Nanotube (SWNT) Electrodes with RTIL:Clay Based Electrolytes

In this Example, Applicants demonstrate the development of activated carbon (AC) and single-wall carbon nanotube (SWNT) electrodes with RTIL-clay composite electrolytes at different temperatures. The RTIL used in this example was BMMI-TFSI. The clay used in this Example was Bentonite clay.

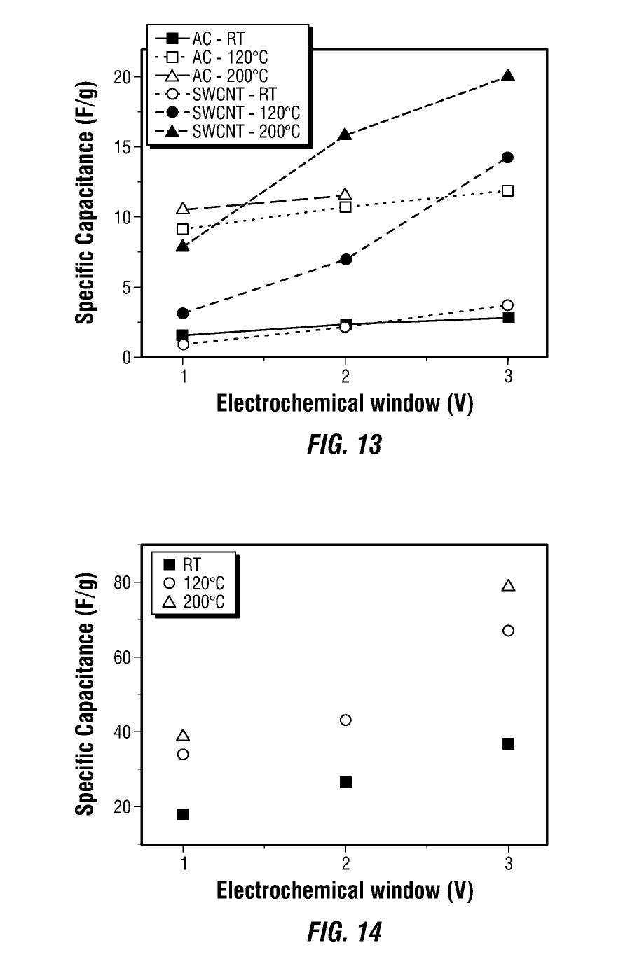

The results are shown in FIGS. 13-14. The results indicate that the electrical capacities can be much higher when using reduced graphene oxide (RGO) electrodes with RTIL-clay composite electrolytes because of the improved percolation of the electrolyte ions within the RGO electrode. Indeed, capacities up to 80 F/g have been achieved at 200° C. with such a device (FIG. 14). Such capacities are presently a record performance at these temperatures.

### Example 3

### Use of Clay-Based Energy Storage Compositions in Batteries

In this Example, variations of clay-based energy storage compositions are used to facilitate the use of lithium-ion batteries at temperatures as high as 120° C. The use of electrolytes consisting of organic solvents with low boiling points (e.g., <80° C.) is the prime limiting factor for using conventional batteries at higher temperatures. In this Example, an energy storage composition comprising bentonite clay and lithiated ionic liquids are used in lithium ion batteries for high temperature applications.

Commercial lithium titanium oxide (LTO) with known electrochemical properties and good thermal stability was chosen as the electrode to understand the electrochemistry of the ionic liquid-clay composite at high temperatures. Discharge capacity of ˜120 mAh g⁻¹ was observed for half-cells cycled using a current density of 20 mAg⁻¹ at 120° C.

### Example 3.1

### Electrolyte Composite Preparation

1M solutions of lithium bis(trifluoromethylsulfonyl)imide (LTFSI) salt in 1-Butyl-2,3-dimethylimidazolium bis(trifluoromethylsulfonyl)imide (hereafter referred to as IM-LTFSI), and 1M solutions of LiTFSI in 1-Butyl-1-methylpiperidinium bis(trifluoromethylsulfonyl)imide (hereafter referred to as PP-LTFSI) were used as electrolytes for high temperature applications. IM-LTFSI and PP-LTFSI were used due to their optimal voltage and thermal stability at high temperatures (i.e., 200° C.).

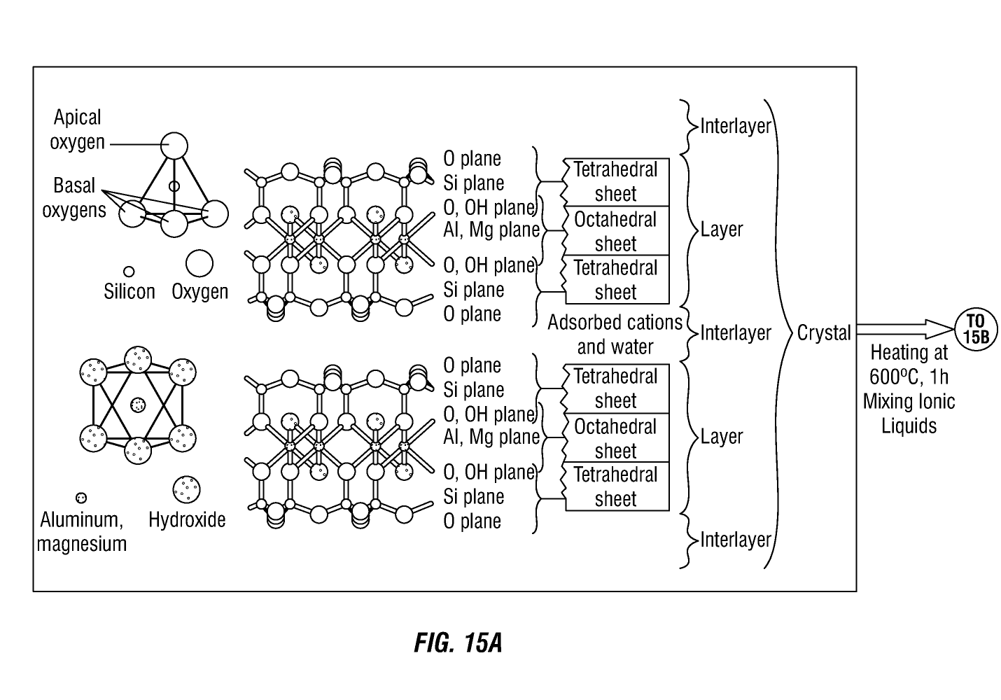

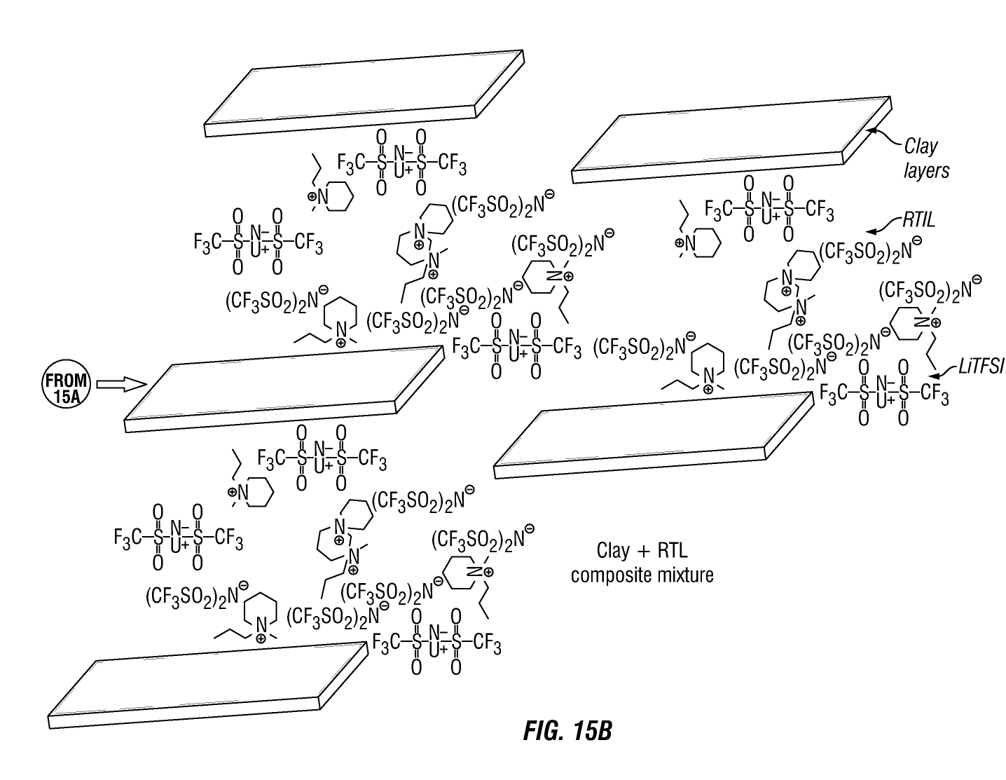

Bentonite clay was dried at 600° C. to remove absorbed moisture and then mixed with appropriate quantities of IM-LTFSI or PP-LTFSI to form uniform slurries of clay-based energy storage compositions (referred to as CIM-LTFSI and CPP-LTFSI, respectively). A scheme describing the electrolyte is provided in FIG. 15.

### Example 3.2

### Electrochemical Cell Assembly

Lithium titanium oxide (LTO) was used as the working electrode due to its known electrochemical properties and thermal stability. The electrode slurry consisting of LTO (80% w/w), Poly-vinyledene fluoride (11% w/w), and carbon black (9% w/w) was prepared using 1-methyl, 2-pyrrolidone (NMP) as the solvent. The slurry was drop coated onto a previously cleaned 1-inch copper current collector and dried at 85° C. under vacuum. The electrolyte composite was sandwiched between the electrodes and packed in a CR2032 type coin cell.

### Example 3.3

### Electrochemical Measurements

Ionic conductivity and cyclic voltammetry (CV) measurements were performed using AUTOLAB PGSTAT 302 N ECOCHEMIE frequency analyzer. To measure the ionic conductivities, the electrolyte was sandwiched between two identical stainless steel discs of known geometries and the electrochemical impedance spectra (EIS) was measured at various temperatures. The EIS measurements were conducted over 70 kHz to 10 mHz by applying a perturbation of 10 mV over the constant open circuit potential. CV measurements were performed at a scan rate of 0.1 mV/s between 1 and 3 V. The electrochemical charge-discharge tests were conducted at different temperatures and various current densities by using the electrochemical testing station from Arbin Instruments, with the potential limits set as 1 and 2 V. In the context of this example, discharge will refer to the process of lithiation of the LTO electrodes, while charge refers to the extraction of lithium ions from LTO.

### Example 3.4

### Results and Discussion

FIG. 1 is a schematic illustration of the entire process from electrolyte preparation to Li-ion battery fabrication. The clay-based energy storage compositions were sandwiched between the active electrode (LTO) and lithium metal. The interface between various components of the battery can be seen in the scanning electron micrograph. There is clear indication of good electrical contact between the battery components and the fluidic nature of the electrolyte at high temperatures. This electrical contact can explain the micro-roughness of the electrode.

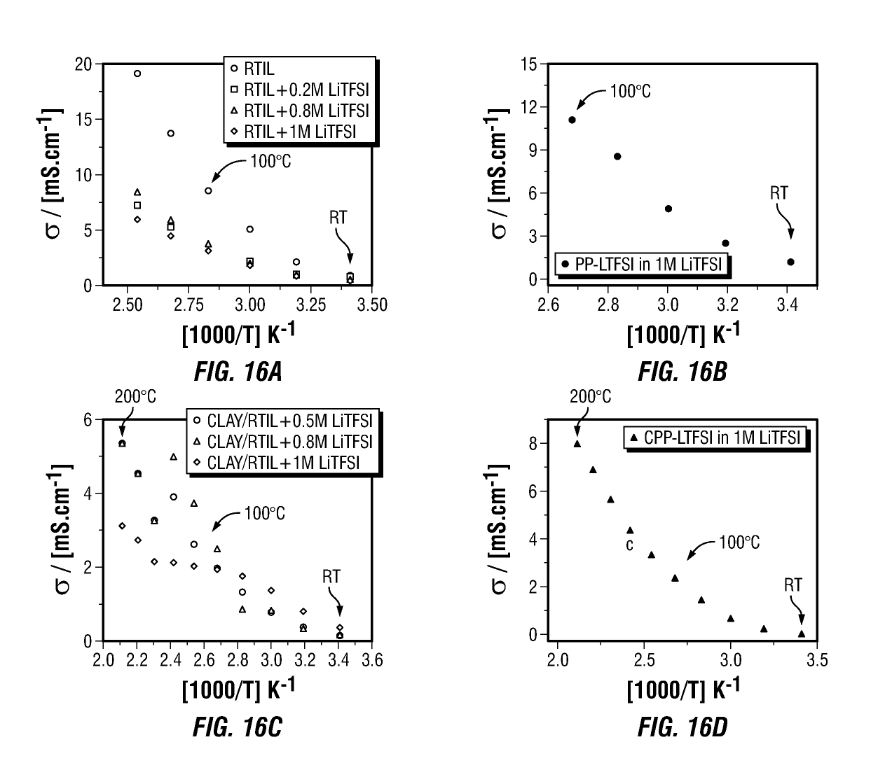

The conductivity of IM-LTFSI was observed to increase with increasing temperature (FIG. 16A). Without being bound by theory, it is envisioned that such an increase is due to the decrease in viscosity of the ionic liquid with increasing temperature, thereby facilitating more ionic diffusion. Addition of more lithium salt increases the viscosity of the solution, thereby resulting in decreased conductivity. A 1M solution of the LiTFSI in ionic liquid was observed to demonstrate the lowest conductivity at all temperatures if compared to solutions with other concentrations. However, this concentration provided the best cell performance and hence it was the one chosen for being used in the electrolyte. Among the ionic liquids under consideration, PP-LTFSI was observed to have better ionic conductivity than IM-LTFSI at temperatures up to 120° C. (FIG. 16B). Thus, PP-LTFSI was chosen for testing in a lithium ion battery.

FIGS. 16C-D show plots of ionic conductivity versus temperature for CIM-LTFSI and CPP-LTFSI, respectively. Addition of clay into the composite does not change the trend in the progression of ionic conductivities with temperature as observed for the LiTFSI solution in RTIL. The ionic conductivity increases with an increase in the temperature and, once ore, CPP-LTFSI was observed to present higher conductivity values than CIM-LTFSI.

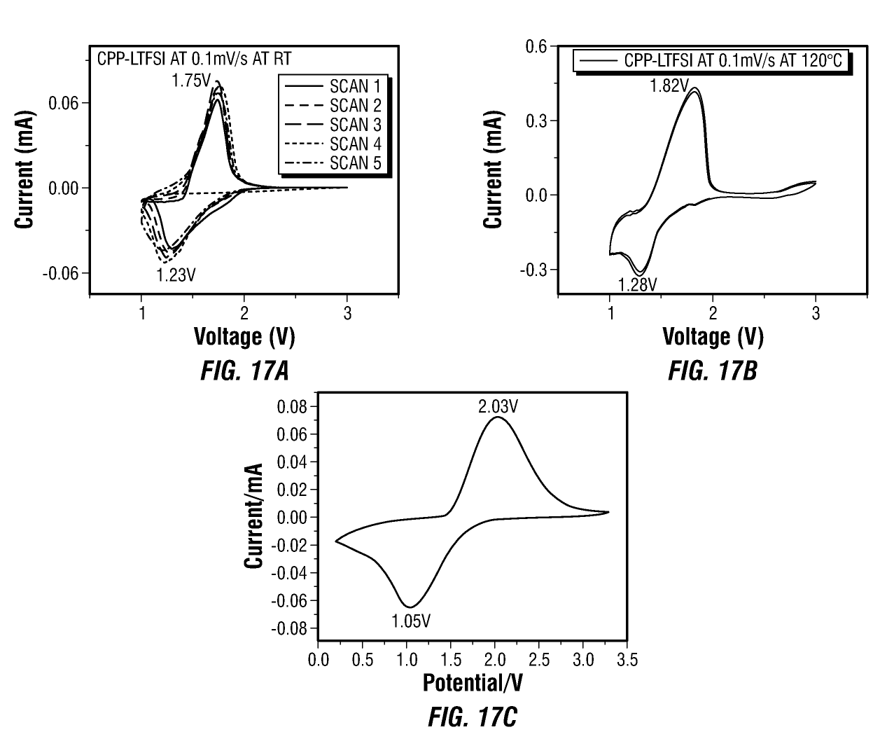

Cyclic voltammetry (CV) tests were performed within 1-3V at room temperature and at 120° C. to understand the electrochemical reactions of assembled half-cells that contained CIM-LTFSI and CPP-LTFSI. FIGS. 17A-B show results for half-cells containing CPP-LTFSI. FIG. 17C shows results for half-cells containing CIM-LTFSI.

Lithiation and de-lithiation peaks for the LTO electrode were observed to be occurring at about 1.25V and at about 1.7V, indicating a slight shift from the theoretical value of 1.6V. Without being bound by theory, this shift can be attributed to the lower ionic conductivities of lithium ions in the composite solution and, as a consequence, there is an over potential associated with the reaction.

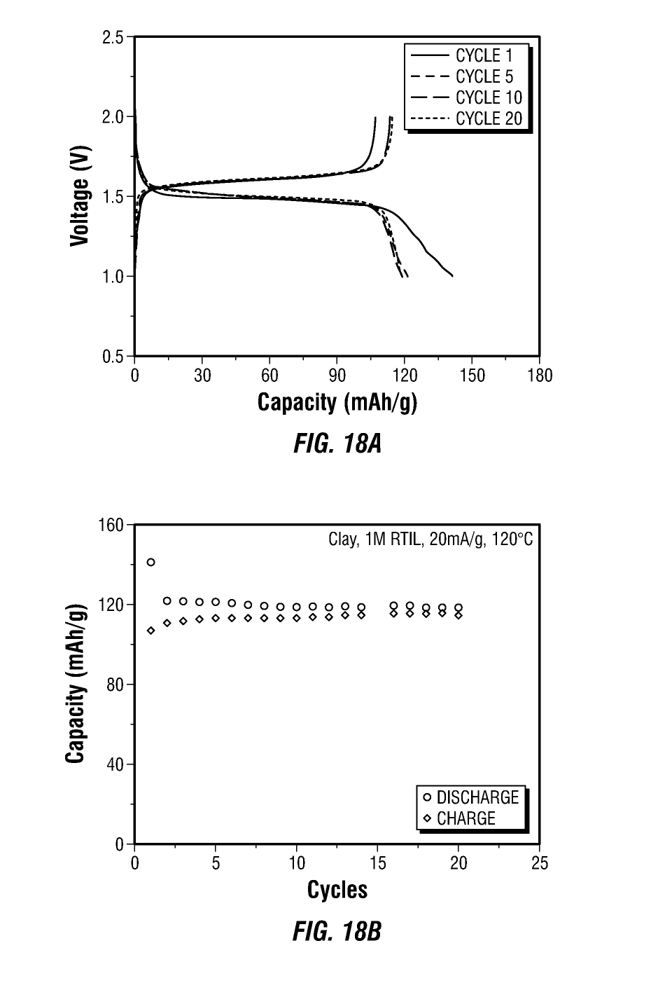

Charge-discharge measurements were conducted at a current density of 20 mA/g, which corresponds to a scan rate of C/6. FIG. 18A shows the voltage profile of the half-cell containing CPP-LTFSI at 120° C. The cell was observed to be extremely stable until a minimum of 20 cycles with very little polarization and a stable plateau. The cyclic stability plot at 120° C. (FIG. 18B) demonstrates the stability of the cell for 20 cycles with a high capacity of 120 mAh g⁻¹. For both electrolytes, half cells tested at different conditions showed an improvement in the capacity by increasing the temperature in which the test was being conducted. This is a consequence of both the observed increase in the ionic conductivity of the electrolyte and in the decrease of its viscosity, thus allowing the electrodes to be more efficiently wet by the electrolyte in a way to reduce the contact resistance.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. An energy storage composition comprising:
a clay; and
an ionic liquid.

2. The energy storage composition of claim 1, wherein the clay is selected from the group consisting of bentonite clay, montmorillonite clay, kaolinite clay, tonstein clay, laponite clay, and combinations thereof.

3. The energy storage composition of claim 1, wherein the clay comprises a bentonite clay.

4. The energy storage composition of claim 1, wherein the ionic liquid comprises a room temperature ionic liquid (RTIL).

5. The energy storage composition of claim 1, wherein a cationic component of the ionic liquid is selected from the group consisting of sulfonium-based structures, imidazolium-based structures, pyridinium-based structures, piperidinium-based structures, pyrrolidinium-based structures, pyrazolium-based structures, ammonium-based structures, phosphonium-based structures, and combinations thereof.

6. The energy storage composition of claim 1, wherein an anionic component of the ionic liquid is selected from the group consisting of bis(trifluoromethylsulfonyl)imide, hexafluorophosphate, methanesulfonate, triflate, tetrafluoroborate, and combinations thereof.

7. The energy storage composition of claim 1, wherein the ionic liquid is selected from the group consisting of 1-Butyl-2,3-dimethylimidazolium bis(trifluoromethylsulfonyl)imide (BMMI-TFSI), 1-Butyl-1-methylpiperidinium bis(trifluoromethylsulfonyl)imide, 1-Butyl-3-methylimidazolium hexafluorophosphate, 1-Butyl-3-methylimidazolium tetrafluoroborate, 1-Methyl-1-propylpiperidinium bis(trifluoromethylsulfonyl)imide, 1-Butyl-1-methylpiperidinium bis(trifluoromethylsulfonyl)imide (PP-TFSI), Diethylmethylsulfonium bis(trifluoromethylsulfonyl)imide, N,N-diethyl-N-methyl-N-(2-methoxyethyl)ammonium bis(trifluoromethylsulfonyl)imide, and combinations thereof.

8. The energy storage composition of claim 1, wherein the ionic liquid is 1-Butyl-2,3-dimethylimidazolium bis(trifluoromethylsulfonyl)imide (BMMI-TFSI).

9. The energy storage composition of claim 1, wherein the ionic liquid is 1-Methyl-1-propylpiperidinium bis(trifluoromethylsulfonyl)imide.

10. The energy storage composition of claim 1, wherein the ionic liquid is 1-Butyl-1-methylpiperidinium bis(trifluoromethylsulfonyl)imide (PP-TFSI).

11. The energy storage composition of claim 1, wherein the ionic liquid is 1-Methyl-1-propylpiperidinium bis(trifluoromethylsulfonyl)imide

12. The energy storage composition of claim 1, wherein the ionic liquid further comprises a salt, wherein the salt is dissolved in the ionic liquid.

13. The energy storage composition of claim 12, wherein the salt is a lithium-containing salt.

14. The energy storage composition of claim 13, wherein the lithium-containing salt is selected from the group consisting of Lithium bis(trifluoromethylsulfonyl)imide (LiTFSI), Lithium Hexafluorophosphate, Lithium Tetrafluoroborate, Lithium bis(oxalate)borate (LiBOB) and combinations thereof.

15. The energy storage composition of claim 13, wherein the lithium-containing salt is Lithium bis(trifluoromethylsulfonyl)imide (LiTFSI).

16. The energy storage composition of claim 13, wherein the lithium-containing salt concentration in the ionic liquid is 1.0 mol L⁻¹.

17. The energy storage composition of claim 1, wherein the clay and the ionic liquid are present in the energy storage composition in a weight ratio of 1:1.

18. The energy storage composition of claim 1, further comprising a thermoplastic polymer.

19. The energy storage composition of claim 18, wherein the thermoplastic polymer is selected from the group consisting of polyurethanes, polyacrylates, polyamides, polyimides, polyimidazoles, polyalkylenes, polystyrene, poly(vinyl chloride), poly(vinylidene difluoride), and combinations thereof.

20. The energy storage composition of claim 18, wherein the thermoplastic polymer is a polyurethane.

21. The energy storage composition of claim 18, wherein the thermoplastic polymer constitutes about 10% by weight of the energy storage composition.

22. The energy storage composition of claim 1, wherein the energy storage composition is in solid form.

23. The energy storage composition of claim 1, wherein the energy storage composition is in the form of a paste.

24. The energy storage composition of claim 1, wherein the energy storage composition is in the form of a film.

25. The energy storage composition of claim 1, wherein the energy storage composition is freestanding.

26. The energy storage composition of claim 1, wherein the energy storage composition is associated with an electrode.

27. The energy storage composition of claim 26, wherein the electrode further comprises at least one of a conductive carbon material, a binder, an inorganic oxide, and combinations thereof.

28. The energy storage composition of claim 26, wherein the electrode comprises a conductive carbon material selected from the group consisting of graphite, graphene oxide (GO), reduced graphene oxide (RGO), activated carbon (AC), carbon nanotubes, and combinations thereof.

29. The energy storage composition of claim 26, wherein the electrode comprises an inorganic oxide selected from the group consisting of Lithium Titanate (LTO, Li₄Ti₅O₁₂), Lithium Cobalt (III) Oxide (LCO, LiCoO₂), Lithium Nickel Manganese Cobalt Oxide, Lithium Iron (II) Phosphate, Lithium Nickel Oxide, Vanadium Oxide and combinations thereof.

30. The energy storage composition of claim 27, where in the inorganic oxide or the conductive carbon material is mixed with at least one of a conductive filler, a binder, and combinations thereof.

31. The energy storage composition of claim 30, wherein the conductive filler is selected from the group consisting of graphite, carbon black, and combinations thereof.

32. The energy storage composition of claim 30, wherein the binder comprises poly(vinylidene difluoride) (PVdF).

33. The energy storage composition of claim 1, wherein the energy storage composition is associated with a separator.

34. The energy storage composition of claim 1, wherein the energy storage composition is associated with an energy storage device.

35. The energy storage composition of claim 34, wherein the energy storage device is a battery.

36. The energy storage composition of claim 34, wherein the energy storage device is a supercapacitor.
